(19) United States
(12) Patent Application Publication
(10) Pub. No.: US 2002/0141570 A1
(43) Pub. Date: Oct. 3, 2002

(54) Low-pass filter usable with caller ID device

(76) Inventors: Ting Sun, San Jose, CA (US); Yan Shi, San Jose, CA (US)

Correspondence Address: CARR & FERRELL LLP, 2225 EAST BAYSHORE ROAD, SUITE 200, PALO ALTO, CA, 94303, US

(21) Appl. No.: 09/825,677

(22) Filed: Apr. 3, 2001

(51) Int. Cl. H04M 1/00; H04M 9/00

(52) U.S. Cl. 379/387.01

(57) ABSTRACT

An odd-order low-pass filter is disclosed for being interposed between a home telephone wiring network and a POTS, or voice-band, device to separate voice-band signals from higher frequency signals, such as ADSL signals and home networking signals. In one embodiment, the filter includes a pair of coupled inductors separated by a capacitor to isolate the POTS device from DSL signals. Each coupled inductor includes a pair of inductor windings wrapped about an inductor core. A resistive element positioned in parallel with each of the windings reduces interference between resonant xDSL signals and operation of an associated caller ID device.

### CROSS-REFERENCE TO RELATED APPLICATIONS

This application relates to U.S. patent application Ser. No. 09/544,731, entitled “Odd-Order Low-Pass POTS Device Microfilter,” filed Apr. 6, 2000 by Ting Sun and Brian L. Hinman, and to U.S. patent application Ser. No. 09/699,223 entitled “Notch Band Reject Microfilter,” filed Oct. 26, 2000 by Ting Sun, Brian L. Hinman, and Yan Shi, the entire disclosures of which are hereby incorporated by reference.

### BACKGROUND

1. Technical Field

The present invention relates to low-pass filters and, more particularly, to a low-pass filter usable with a caller ID device.

2. Description of the Background Art

With the advent of xDSL and home networking data transmission technologies, it may be desirable to have xDSL signals, home networking signals, or both present on a home telephone wiring network simultaneously with voice-band signals. Voice-band signals are commonly referred to as POTS (Plain Old Telephone Service) signals and generally reside below about 4 KHz. Providing xDSL service, home networking, and POTS over standard telephone lines permits the home telephone wiring network to operate as a local area network (LAN), while at the same time permitting voice-band and xDSL service to be transmitted across the home telephone wiring network.

Despite the advantages of providing xDSL, home networking, and POTS signals simultaneously over a common network, it is desirable to prevent energy from the xDSL and/or home networking signal carriers from reaching voice-band, or POTS, appliances coupled to the network. Voice-band appliances may include, for example, telephone sets, facsimile machines, 56K modems, and the like. Indeed, energy from the xDSL or home networking signal carriers may cause the non-linear behavior of the voice-band appliances to create noise into the POTS connection. Further preventing xDSL and home networking signals from reaching voice-band appliances protects the xDSL and home networking transports from high-frequency inter-modulation products of the voice-band appliances.

In addition, voice-band appliances typically undergo impedance changes during operation. For example, state changes in a POTS device such as on/off hook, dialing, and ringing tend to affect the impedance of the POTS device. This change in impedance, unless isolated from the xDSL and home networking devices, may limit the throughput of the xDSL or home networking devices and may require dynamic bit reloading inter-modulation and line retraining.

In the past, it has been proposed to use low-pass filters disposed between a home telephone wiring network and each of the POTS devices, such as telephones, coupled thereto. Pursuant to this arrangement, both the DSL modem and the POTS devices would receive signals from the same pair of wires entering the subscriber premises from the central office with no need for a POTS splitter disposed at the NID.

Odd order low pass filters may be disposed between a POTS device and the home telephone wiring network to prevent DSL signals from interfering with operation of the POTS device and to prevent impedance changes in the POTS device from adversely affecting DSL service. In this configuration, the DSL signals may resonate between the capacitance of an on-hook POTS device and the inductor oriented closest to or adjacent to the on-hook POTS device

It has been found that, however, this resonance impairs operation of some caller ID circuitry. Specifically, the resonance tends to create a spike of energy above the POTS band that may saturate receiver components of the caller ID circuitry, which may prevent the caller ID from properly receiving the caller ID information.

Accordingly, a need exists to provide a low pass filter for disposal between a POTS device and a home telephone wiring network to separate ADSL and POTS band signals without impairing operation of associated caller ID circuitry.

### SUMMARY

An odd-order low pass filter for use between in-premises telephone wiring and a POTS device with associated caller ID circuitry includes a pair of coupled inductors separated by a capacitor to isolate the POTS device from DSL signals. Each coupled inductor includes a pair of inductor windings wrapped about an inductor core. A resistive element positioned in parallel with each of the windings of one of the coupled inductors reduces interference between resonant xDSL signals and operation of the caller ID device.

In one embodiment, each of the coupled inductor windings has an inductance in the range of about 3-8 mH the capacitor has a capacitance in the range of 22-68 nanofarads. Each of the resistive elements has a resistance of about 500-5000 ohms, and preferably a resistance of about 680 ohms. If the resistance of the resistive elements is significantly below 500 ohms, the filter may not sufficiently attenuate DSL-band signals. However, if the resistance of the resistive elements is significantly greater than 5000 ohms, a spike of DSL-band energy will pass through the filter to the caller ID circuitry, potentially impairing or preventing proper operation of the caller ID circuitry

Conventionally, odd-order low pass filters for use with a POTS device for separating DSL signals from POTS signals on in-premises telephone wiring permit a spike of DSL-band energy to pass through the filter due, at least in part, to resonance between capacitive elements in an on-hook POTS device and the filter inductive elements adjacent to the POTS device. This spike of DSL-band energy may saturate operational amplifier components of caller ID equipment, thus preventing proper operation thereof. The present filter reduces the magnitude of this spike, thereby reducing the likelihood of DSL-band signals interfering with caller ID service.

Other advantages and features of the present invention will be apparent from the drawings and detailed description as set forth below.

### BRIEF DESCRIPTION OF THE DRAWINGS

FIG. 1 is a block diagram illustrating an ADSL and POTS service network;

FIG. 2 is a block diagram of a prior art implementation of one of the FIG. 1 filters;

FIG. 3 is a block diagram illustrating details of prior art caller ID device circuitry;

FIG. 4 illustrates details of one embodiment of a FIG. 1 filter in accordance with the present invention;

FIG. 5 is a plot of the on-hook frequency response, or insertion loss, of embodiments of a FIG. 1 filter; and

FIG. 6 is a plot of the off-hook frequency response, or insertion loss, of embodiments of a FIG. 1 filter.

### DETAILED DESCRIPTION

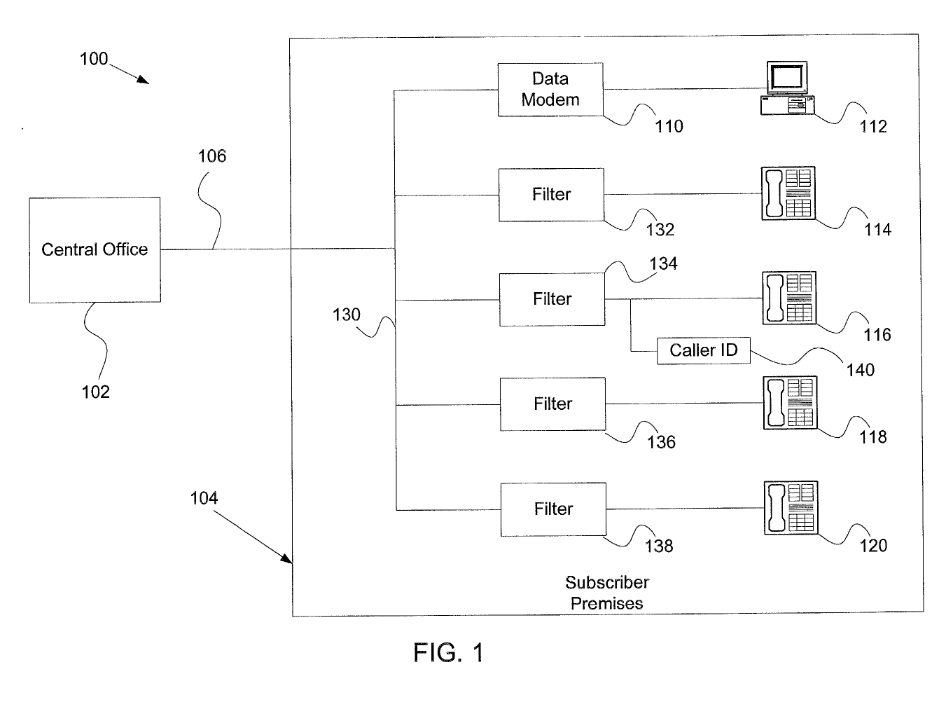

FIG. 1 illustrates a data and POTS service network 100 that includes a central office 102 including a Digital Subscriber Line Access Muliplexer (not shown) and a subscriber premises, such as home 104 coupled by a loop 106. In this configuration, the central office 102 may provide POTS and data service, such as DSL service, to the home 104 over the loop 106. As those skilled in the art will appreciate, the loop 106 may comprise a pair of twisted copper conductors, generally known as a “twisted pair.”

The home 104 is shown as including, a data modem 110, a computer 112, and POTS devices, such as telephones 114, 116, 118, and 120. Other types of POTS devices include facsimile machines, message machines, and voice-band modems. As shown, each POTS device 114-120 is coupled to a network of in-premises telephone wiring network 130 by one of the low pass filters 132, 134, 136, and 138 to substantially isolate the associated POTS devices from data signals, such as ADSL signals that may be present on the wiring network 130. Indeed, as shown, the wiring network 130 is coupled directly to the loop 106 and therefore may have POTS signals, data signals, or both simultaneously thereon.

In this configuration, the central office 102 may provide splitterless ADSL service over the loop 106 to the data modem 110 via the wiring network 130 while, at the same time providing POTS service to the POTS devices 114-120 over the same wiring. The low pass filters 132-138 generally reduce interference between the POTS and data services.

A caller ID device 140 is also illustrated as being coupled to the wiring network 130 via the filter 134. When the filter 134 comprises an odd-order three-pole low pass filter, and the POTS device 116 is in an on-hook state, DSL signals on the wiring network 130 may resonate between a capacitive elements in the POTS device 116 and inductive elements in the filter 134, thereby creating a spike of energy in the DSL band. This spike of energy may limit, or adversely affect, the ability of the caller ID device 140 to properly receive caller ID signals sent from the central office 102. Additional details regarding conventional filters, caller ID circuitry, and this spike of energy in the DSL band are described in more detail below. In addition, a novel filter design is described, which overcomes or substantially alleviates problems associated with this energy spike.

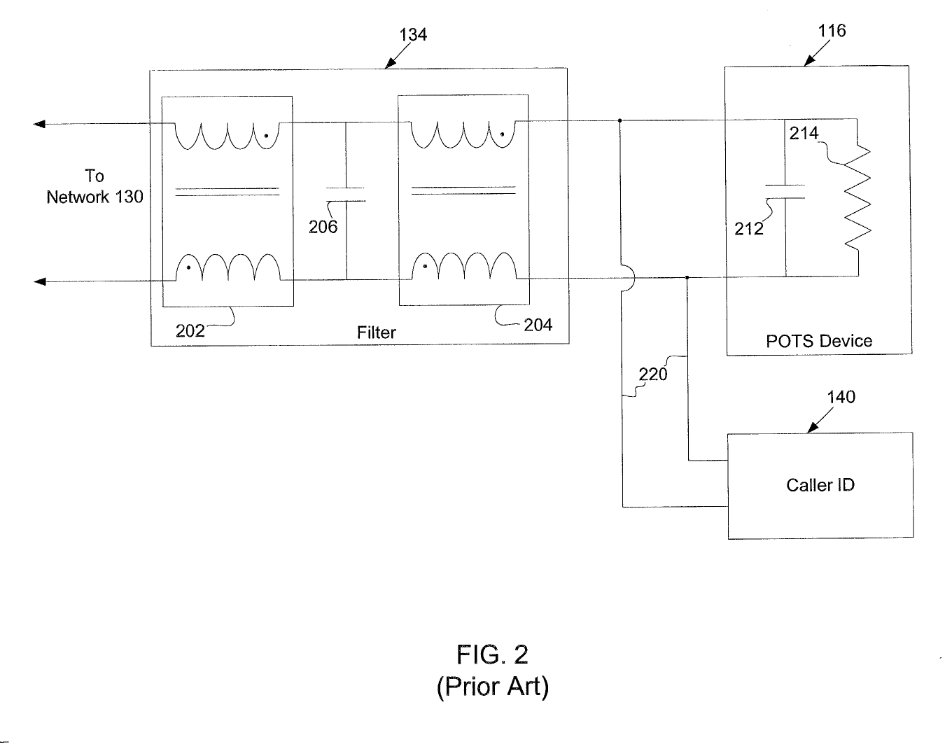

FIG. 2 illustrates details of a prior art embodiment of FIG. 1 filter 134. The filters 132, 136, and 138 may be configured identically to the filter 134. As shown in FIG. 2, a prior art implementation of a low pass filter 134 includes coupled inductors 202 and 204 connected in series between the network 130 and the devices 116 and 140. A capacitor 206 is disposed between the coupled inductors between the input of one of the coupled inductors and the output of the other coupled inductor. In this configuration, the filter 134 attenuates DSL signals so that they do not interfere with operation of the POTS device 116 when the POTS device 116 is off hook.

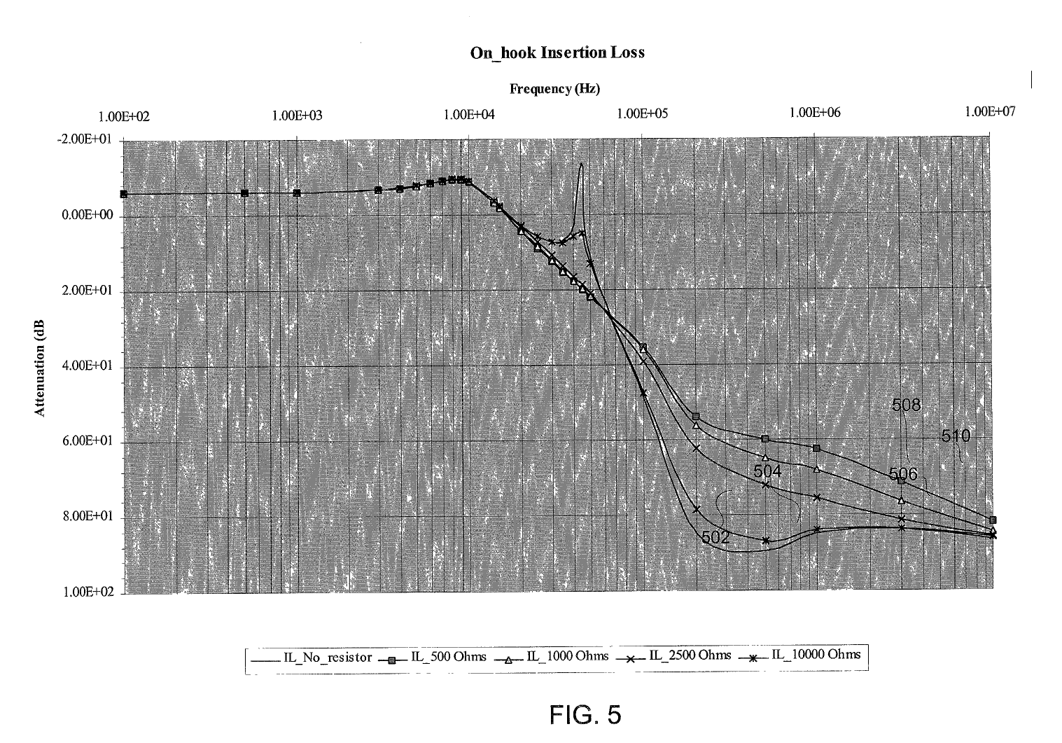

The on-hook POTS device 116 is shown as presenting the approximate equivalent of a 1 nF capacitor 212 in parallel with a 5 Mega-ohm resistor. When the POTS device 116 is on-hook, DSL signals tend to resonate between the capacitor 212 and the coupled inductor 204, thereby creating a spike in the DSL band that may impair proper operation of the caller ID device 140, which is shown as being coupled to the filter 134 via lines 220. Details regarding this spike are illustrated in FIG. 5 and are discussed below. Those skilled in the art will appreciate that the caller ID device 140 may comprise caller ID circuitry that is disposed in a common housing with the POTS device 116 or in a separate housing as shown in FIG. 2.

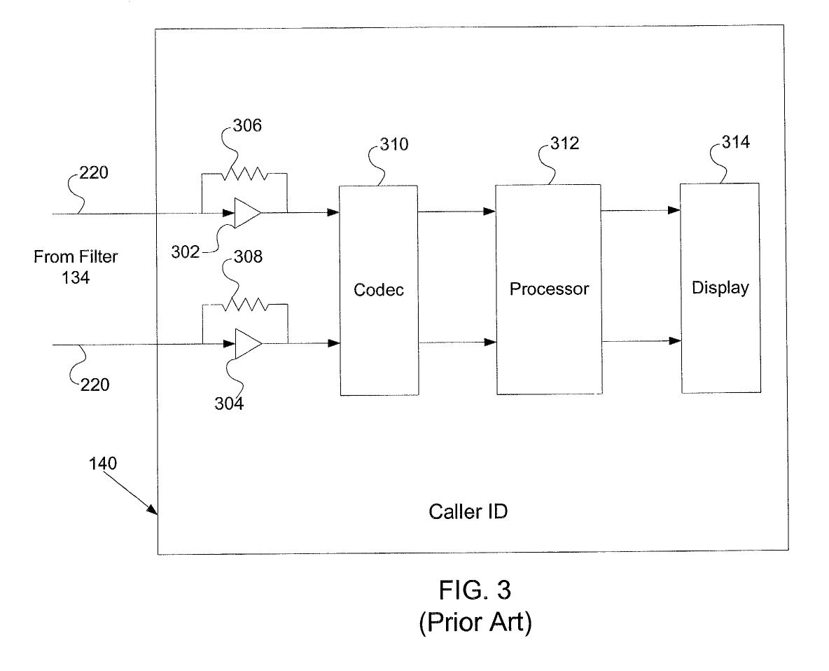

FIG. 3 illustrates details of one implementation of prior art caller ID circuitry. Those skilled in the art are aware that caller ID is a telephone company service that sends information regarding a caller's telephone number to the party being called. Caller ID circuitry receives this caller ID information and may display such information for the benefit of the party being called. As shown, the caller ID device 140 includes operational amplifiers 302 and 304 with associated resistors 306 and 308, which serve to receive and amplify incoming caller ID signals from the central office 102 over the loop 106 and the wiring network 130 (FIG. 1). A codec 310 is coupled to the operational amplifiers 310 and converts the incoming analog caller ID signals from the operational amplifiers 302 and 304 to digital signals and passes the digital signals to a data processor 312. The processor 312 processes the incoming signals and drives a display 314 to display the telephone number of the current caller.

Using conventional three-pole odd-order low pass filters, the spike of DSL-band energy discussed above may saturate the operational amplifiers 302 and 304, thereby preventing or limiting the ability of the operational amplifiers to properly receive caller ID signals.

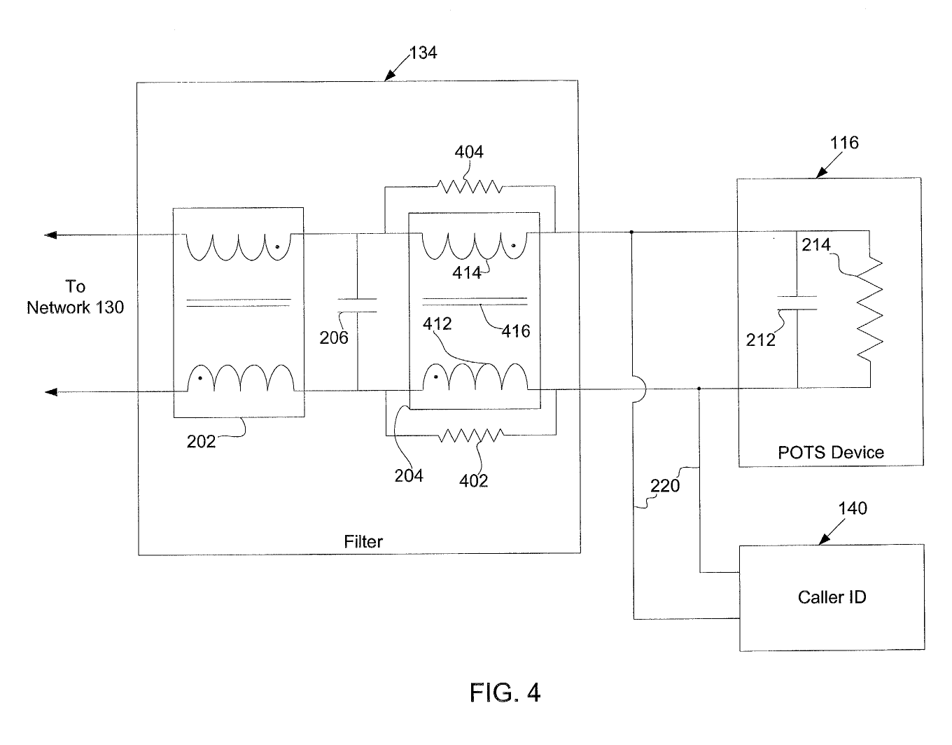

FIG. 4 illustrates a filter 134 in accordance with one embodiment of the present invention. As shown, the filter 134 includes coupled inductors 202 and 204 and a capacitor 206. In one embodiment, the windings of the coupled inductors 202 and 204 each have an inductance in the range of about 3- 8 mH and preferably an inductance of about 5.5 mH. Moreover, it may be desirable, in some applications, for each of the coupled inductors 202 and 204 to have an inter-winding capacitance greater than about 100 pF in the frequency range of about 10 KHz-100 KHz. The capacitor 206 has a capacitance in the range of about 22-68 nanofarads, and preferably about 47 micro farads.

Resistive elements, such as resistors 402 and 404, are illustrated as being respectively disposed in parallel with the windings 412 and 414 of an inductive element, such as the coupled inductor 204. The windings 412 and 414 are wrapped about an inductor core 416. The coupled inductor 204 is the coupled inductor adjacent to or closest to the POTS device 116. The resistors 402 and 404 each advantageously have a resistance in the range of about 500-5000 ohms, and preferably a resistance of about 680 ohms. The resistors 402 and 404 generally reduce the magnitude of a DSL-band energy spike that is created as DSL signal energy resonates between the capacitance 212 of the POTS device 116 and the coupled inductor 204. As discussed above, this spike of DSL-band energy may impair proper operation of the caller ID device 140. Additional details regarding this spike of DSL-band energy are described below.

In general, the resistance of the resistors 402 and 404 are advantageously in the range of about 500-5000 ohms. If the resistance of the resistors 402 and 404 is much above 5000 ohms, the resistors will not sufficiently reduce the magnitude of the spike of DSL-band energy to prevent interference with operation of associated caller ID equipment. However, it has also been found that use of resistors 402 and 404 having resistances significantly less than about 500 ohms, the filter will not sufficiently attenuate signals in the lower portion of the ADSL band, such as signals at about 26 KHz.

FIG. 4 shows a three-pole third-order filter. Those skilled in the art will appreciate, however, that the present invention is also applicable to other odd-order filters. For example, a fifth-order filter may comprise three coupled inductors disposed in series with a capacitor disposed between each of the coupled inductors. Pursuant to the present invention, resistive elements are then disposed in parallel with the windings of the coupled inductor closest to the associated caller ID device. Moreover, those skilled in the art will likewise appreciate that uncoupled inductors may be employed instead of the coupled inductors described herein.

FIG. 5 illustrates the on-hook frequency response, or on-hook insertion loss, of embodiments of a FIG. 4 filter. As shown, FIG. 5 contains plots 502, 504, 506, 508, and 510 illustrating embodiments of a FIG. 4 filter with different values for the resistors 402 and 404. The plot 502 illustrates the on-hook frequency response for a FIG. 4 filter having no resistors 402 and 404. The plot 502 contains a spike of DSL-band energy at about 55 KHz, which may impair or prevent proper operation of caller ID circuitry, such as that described above with reference to FIG. 3. The plot 504 illustrates the on-hook frequency response for a FIG. 4 filter where the resistors 402 and 404 each have a resistance of about 10,000 ohms. The plot 504 also contains a spike of DSL-band energy at about 55 KHz, which may impair or prevent proper operation of caller ID circuitry, such as that described above with reference to FIG. 3.

The plot 506 illustrates the on-hook frequency response for a FIG. 4 filter where the resistors 402 and 404 each have a resistance of about 2,500 ohms. As shown, the plot 506 does not include a spike of energy in the DSL band like the plots 502 and 504, thus illustrating that resistors of about 2,500 ohms sufficiently reduce the magnitude of the spike of DSL energy that might impair operation of caller ID circuitry, such as that shown in FIG. 3.

The plot 508 illustrates the on-hook frequency response for a FIG. 4 filter where the resistors 402 and 404 each have a resistance of about 1000 ohms. As shown, the plot 508 does not include a spike of energy in the DSL band like the plots 502 and 504, thus illustrating that resistors of about 1000 ohms sufficiently reduce the magnitude of the spike of DSL energy that might impair operation of caller ID circuitry, such as that shown in FIG. 3.

The plot 510 illustrates the on-hook frequency response for a FIG. 4 filter where the resistors 402 and 404 each have a resistance of about 500 ohms. As shown, the plot 510 does not include a spike of energy in the DSL band like the plots 502 and 504, thus illustrating that resistors of about 500 ohms sufficiently reduce the magnitude of the spike of DSL energy that might impair operation of caller ID circuitry, such as that shown in FIG. 3.

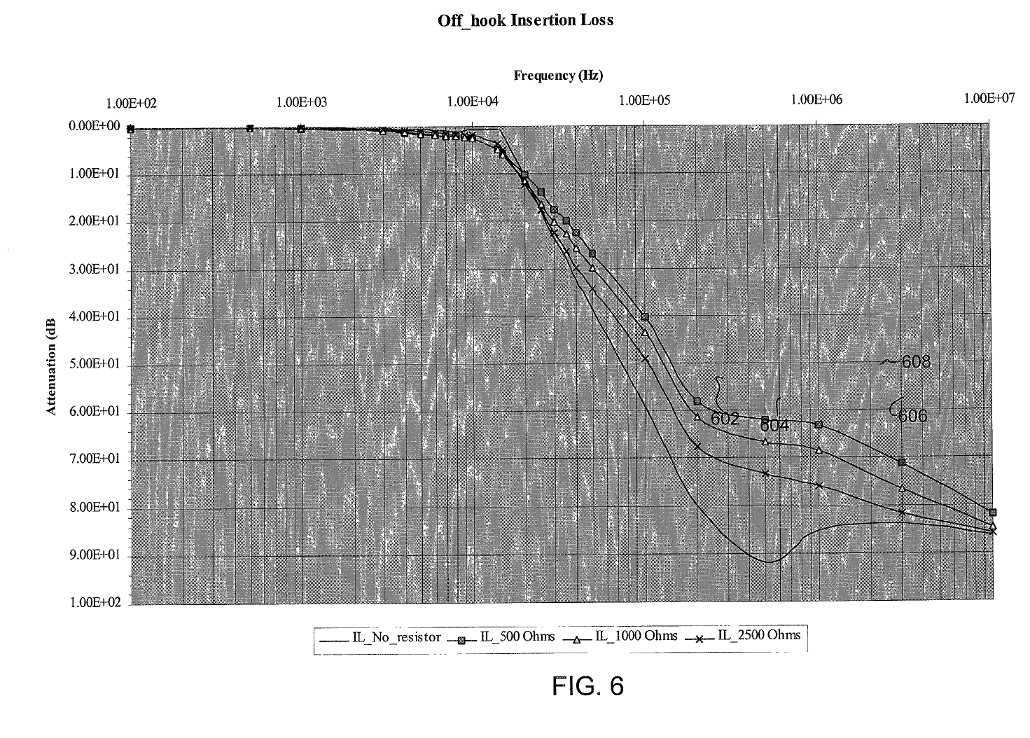

FIG. 6 illustrates the off-hook frequency response, or off-hook insertion loss, of embodiments of a FIG. 4 filter. As shown, FIG. 6 contains plots 602, 604, 606, and 608, illustrating embodiments of a FIG. 4 filter with different values for the resistors 402 and 404. The plot 602 illustrates the off-hook frequency response for a FIG. 4 filter having no resistors 402 and 404, and shows that such a filter provides over 17 dB of attenuation of 26 KHz signals. The plot 604 illustrates an off-hook frequency response for a FIG. 4 filter where the resistors 402 and 404 each have a resistance of 2,500 ohms and shows that this filter provides over 17 dB of attenuation to 26 KHz signals. The plot 606 illustrates an off-hook frequency response for a FIG. 4 filter where the resistors 402 and 404 each have a resistance of 1,000 ohms and shows that this filter provides over 17 dB of attenuation to 26 KHz signals. Lastly, the plot 608 illustrates an off-hook frequency response for a FIG. 4 filter where the resistors 402 and 404 each have a resistance of 500 ohms and shows that this filter provides about 15 dB of attenuation to 26 KHz signals

It has been found that when the filter of FIG. 4 is configured with resistors 402 and 404 having resistance significantly less than about 500 ohms, the filter provides less than about 15 dB of attenuation to 26 KHz signals and, therefore, may not adequately isolate the associated POTS device from the DSL service provided over the network 130.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. An odd-order low-pass filter for insertion between a POTS device and a home telephone wiring network to separate certain high frequency signals on the home telephone wiring network from the POTS device, the filter comprising:
a first coupled inductor having a pair of windings wrapped about a core;
a second coupled inductor having a pair of windings wrapped about a core;
a capacitive element disposed between the first and the second coupled inductors and separated from the home telephone wiring network by either the first or the second coupled inductor to prevent high frequency signals from being shorted across the capacitor regardless of whether the home telephone wiring network is coupled to the filter adjacent to the first or the second coupled inductor;
a first resistive element disposed in parallel with the one of the windings of the first coupled inductor and a second resistive element disposed in parallel with the other winding of the first coupled inductor to reduce resonance of certain signals between the first coupled inductor and a capacitive element of the associated POTS device.

2. The odd-order low-pass filter of claim 1, wherein the capacitive element has a capacitance in the range of 22-68 nanofarads.

3. The odd-order low-pass filter of claim 1, wherein the first and second resistive elements each have a resistance in the range of 500-5000 ohms.

4. The odd-order low-pass filter of claim 1, wherein each winding has an inductance in the range of 3-8 mH.

5. In a communications network including a DSL modem, a POTS device, and a caller ID device coupled to in-premises telephone wiring, an odd-order low pass filter comprising:
a first coupled inductor having a pair of windings wrapped about a core;
a second coupled inductor having a pair of windings wrapped about a core;
a capacitive element disposed between the first and the second coupled inductors and separated from the home telephone wiring network by either the first or the second coupled inductor to prevent high frequency signals from being shorted across the capacitor regardless of whether the home telephone wiring network is coupled to the filter adjacent to the first or the second coupled inductor;
a first resistive element disposed in parallel with the one of the windings of the first coupled inductor and a second resistive element disposed in parallel with the other winding of the first coupled inductor, the first and second resistive elements preventing resonance of certain signals between the first coupled inductor and capacitive elements of the associated POTS device from interfering with operation of the caller ID device.

6. The odd-order low-pass filter of claim 5, wherein the capacitive element has a capacitance in the range of 22-68 nanofarads.

7. The odd-order low-pass filter of claim 5, wherein the first and second resistive elements each have a resistance in the range of 500-5000 ohms.

8. The odd-order low-pass filter of claim 5, wherein each winding has an inductance in the range of 3-8 mH.

9. An odd-order low-pass filter for insertion between a POTS device and a home telephone wiring network to separate certain high frequency signals on the home telephone wiring network from the POTS device, the filter comprising:
a first pair of inductor windings;
a second pair of inductor windings, each of the second pair of windings disposed in series with one of the windings of the first pair of windings;
a capacitive element disposed between the first and the second pairs of inductor windings and separated from the home telephone wiring network by the first pair of inductor windings to prevent high frequency signals from being shorted across the capacitor;
a first resistive element disposed in parallel with the one of the second pair of inductor windings and a second resistive element disposed in parallel with the other winding of the first pair of inductor windings to reduce resonance of certain signals between the first coupled inductor and a capacitive element of the associated POTS device.

10. The odd-order low-pass filter of claim 9, wherein the first pair of inductor windings are both wrapped about a first inductor core and the second pair of inductor windings are both wrapped about a second inductor core.

11. The odd-order low-pass filter of claim 9, wherein the first and second resistive elements each have a resistance in the range of 500-5000 ohms.
